(19) United States
(12) Patent Application Publication
(10) Pub. No.: US 2021/0124751 A1
(43) Pub. Date: Apr. 29, 2021

(54) Prescriptive Recommendation System and Method for Enhanced Speed and Efficiency in Rule Discovery from Data in Process Monitoring

(71) Applicant: MondoBrain, Inc., NEW YORK, NY (US)

(72) Inventor: GREG JENNINGS, DRIPPING SPRINGS, TX (US)

(73) Assignee: MondoBrain, Inc., NEW YORK, NY (US)

(21) Appl. No.: 17/078,085

(22) Filed: Oct. 22, 2020

Related U.S. Application Data
(60) Provisional application No. 62/925,003, filed on Oct. 23, 2019.

(51) Int. Cl. G06F 16/25; G06F 16/22; G06F 3/0482; G06N 5/02; G06N 5/04; G06F 9/54

(52) U.S. Cl. CPC G06F 16/254; G06F 16/2264; G06F 16/252; G06F 9/547; G06N 5/022; G06N 5/04; G06F 3/0482

(57) ABSTRACT

A computer implemented system for controlling equipment setting and/or providing and interactive data display interface to for a predictive recommendation system. A method is described for constructing and storing a data structure that allows greatly increased speed improvements in analyzing available data sets, identifying data most relevant to a desired outcome, and providing an interpretable result that can be used to alter physical system parameters. The system allows for discovery of explanations for observed outcomes within data and is used to generate recommendations that drive those outcomes toward desired states and avoid undesired states. Users may direct the system to analyze variables (data) to discover explanations leading toward desired outcomes or discover explanations to avoid undesired outcomes. Variables analyzed may include, for example, tolerances and dimensions for a component shape. This output is then used to perform an action that will alter that physical component. The method of constructing a data structure allows tremendous performance improvements in multidimensional data analysis on otherwise comparable systems. The data structure represents the relative position of ranges of data in a data set of arbitrary dimension and arbitrary modalities. The method includes steps of ingesting data; evaluating the data and assigning data types to the variables under consideration; transforming data into a flattened data structure and creating a two dimensional index; and storing the data in five constituent elements.

### CROSS REFERENCE TO RELATED APPLICATION AND CLAIM TO PRIORITY

This application claims the benefit of the inventor's Provisional Patent Application No. 62/925,003 filed Oct. 23, 2019 for “System and Method for Enhanced Speed and efficiency in Rule Discovery from Data.”

### BACKGROUND

### Field of Invention

The present invention relates to a computer implemented predictive recommendation system and method used to provide equipment control signals or interactive data display control for identifying and qualifying sources of data, collecting, filtering and analyzing data and transforming the data into visual images associated with a selected interactive framework that is useful as a tool for managers to optimize enterprise performance. Novel engines improve the efficiency of data processing system and transforming sources of data to facilitate filtering and analyzing the data and transforming the result into natural language and graphical representations, and is useful as a tool for managers to optimize processes.

### 2. Background of the Invention

Since the mid-20th century, the field of business management has revolutionized business and industry. Consultants such as Peter Drucker and W. Edwards Deming, along with numerous others have developed approaches and frameworks to improve organizational processes. These approaches and frameworks range include Lean, Six Sigma, and other variants that aid the complex decision-making processes associated with improving complex phenomena. These complex decisions are informed by both historical data about the process and related processes, and the expertise of human decision makers.

Historically, the ability to extract relevant knowledge from data to inform complex decisions has been limited by the analytical approaches used within these methodologies. For example, in Six Sigma approach, one often uses multiple linear regression and ANOVA (analysis of variance). Both techniques apply at the global level, and thus may be blind to the effects of certain variables that present themselves as influential to the outcome only within a localized context, but which globally, appear to have little or no influence.

Known techniques for facilitating data analysis have been included in a number of automated analytical systems and platforms. For example, U.S. Pat. No. 10,366,346 discusses systems and techniques for data analysis systems and techniques for using statistical learning methods to develop, select, and/or understand predictive models for prediction problems. That patent references an automated system that facilitates data analysis using many of these global techniques.

To gain insight into local effects, inventors and researchers have posited alternative ways to assess information on a more local level. Overall, the task of dividing a dataset into subsets of similar items and similar techniques are sometimes referred to under the broad category of clustering, and their embodiments select features where each member m of a selected training population will have feature values for each of the ten features. However, using current systems and processes poses limits to data analysis on a local level that this invention overcomes.

As used here, a dataset (or data collection) is a set of items in predictive analysis. Items can also be referred to as instances, observations, entities or data objects. In most cases, a dataset is represented in table format—a data matrix.

A data matrix is a table of numbers, documents, or expressions, represented in rows and columns as follows:
Each row corresponds to a given item in the dataset.
Rows are sometimes referred to as items, objects, instances, or observations.
Each column represents a characteristic of an item.
Columns are referred to as features or attributes.

These subsets of the number of observations contain certain relationships between the observations. One way to evaluate the relationship of the subpopulation to the mean (average) of a group of values can be a Z-score of the subpopulation relative to the overall population, which is a numerical measurement used in statistics of a value's relationship to the mean of a group of values, measured in terms of standard deviations from the mean. If a Z-score is 0, it indicates that the data point's value is identical to the population mean.

Clustering, the broad category previously mentioned, involves selecting points that are similar to other points. The next step is to retrieve cluster representatives of each group. For example, a cluster representative would be picking one fruit type from the basket and putting it aside. The characteristics of this fruit are such that that fruit best represents the cluster it belongs to. When the clustering is complete, the dataset is then organized and divided into natural groupings.

Data clustering reveals structure in the data by extracting natural groupings from a dataset. Therefore, discovering clusters is an essential step toward formulating ideas and hypotheses about the structure of your data and deriving insights to better understand it. Naturally, the ability to discover clusters and identify natural groupings improves as the number of datasets increases, but the processing challenge also increases. Thus, there is a need to improve the speed at which data sets are processed. The complexity becomes exponential when the dataset is large, diverse, and relatively incoherent.

Data clustering can also identify, learn, or predict the nature of new data items especially how new data can be linked with making predictions. For example, in pattern recognition, analyzing patterns in the data (such as buying patterns in particular regions or age groups) can help develop predictive analytics—in this case, predicting the nature of future data items that can fit well with established patterns.

Clustering is described on pages 211-256 of Duda and Hart, Pattern Classification and Scene Analysis, 1973, John Wiley & Sons, Inc., New York, (hereinafter “Duda 1973”) which is hereby incorporated by reference in its entirety. As described in Section 6.7 of Duda 1973, the clustering problem is described as one of finding natural groupings in a dataset. To identify natural groupings, two issues are addressed. First, a way to measure similarity (or dissimilarity) between two samples is determined. This metric (similarity measure) is used to ensure that the samples in one cluster are more like one another than they are to samples in other clusters. Second, a mechanism for partitioning the data into clusters using the similarity measure is determined.

This approach is outlined at a high level in U.S. Pat. No. 10,430,725 with a specific implementation around clustering of biomarkers. In this case, the invention selects such values from a member m in the training population define the vector: x.sub.1m X.sub.2m X.sub.3m X.sub.4m X.sub.5m X.sub.6m X.sub.7m X.sub.8m X.sub.9m X.sub.l0m where X.sub.im is the expression level of the i.sup.th biomarker in organism m.

Those members of the training population that exhibit similar expression patterns across the training group will tend to cluster together. A particular combination of genes of the present invention is considered to be a good classifier in this aspect of the invention when the vectors cluster into the trait groups found in the training population. For instance, if the training population includes class a: subjects that do not develop sepsis, and class b: subjects that develop sepsis, an ideal clustering classifier will cluster the population into two groups, with one cluster group uniquely representing class a and the other cluster group uniquely representing class b.

Missing data is a common problem for data clustering quality. Most real-life datasets have missing data, which in turn has some effect on clustering tasks. One limitation of typical clustering approaches is their inability to gracefully handle missing data. For example, in the clustering approach described above, the missing expression value is assigned either a “zero” or some other normalized value. This approach is called imputation.

### SUMMARY

The invention addresses the challenges of previous approaches by providing a system and method for analyzing available data sets, identifying data most relevant to a desired outcome, and providing an interpretable result that can be used to alter physical system parameters. The system allows for discovery of explanations for observed outcomes within data and generate recommendations to drive those outcomes toward desired stats and avoid undesired states. Users may analyze variables (data) to drive a variable toward a desired outcome or drive a variable to avoid an undesired outcome. Variables analyzed may include, for example, tolerances for a component shape. This output is then used to perform an action that will alter a physical component.

The output through the user interface reveals a descriptive course of action, which specifies how to improve a process by identifying key variables and the configuration of those variables. Nominal values and tolerance values in numerical variables and the discrete modalities in categorical variables (need to select a variable among a set choice). Finding optimal configurations of data sets require massive processing data in an extremely high performance and a high-speed solver engine is provided—throwing resources at this problem is not practical for scale.

The system includes improved processing engines, a high-speed solver engine, that allow the system to provide options to view data and gain insight that amplifies human intelligence. The engines described herein are generally applicable to any structured data highly adaptable to a user's existing data sets. The system architecture including the use of the novel software engines improves data processing by up to 100 times for repeated filtering operations on larger datasets.

To avoid limitations associated with imputation of missing data, the approach described herein uses an agglomerative approach that does not require imputation (an approach that involves replacing missing values with other values). This is because with an agglomerative or “bottoms-up” approach each data point starts in its own cluster, and pairs of clusters are merged as one moves up the hierarchy. The goal of this is to produce optimized prescriptive rules that can be interpreted and used to adjust the physical properties of a system.

The rules generated are in response to a question posed, of the following form:
When:
Here the user may specify conditions associated with the structure of the question
For example, “When: feature F1 is category F1C2”
In this case, F1 is a feature of the dataset, and F1C2 is a category that exists within feature F1
For example 2, “When: feature F2 is between F2R1 and F2R2”
In this case, F2 is a feature of the dataset, and both F2R1 and F2R2 are category that exists within feature F1
Change:
Here the user specifies the feature about which they wish to ask an explanatory question, which will generate a context specific insight
For example, “Change: feature F3”
In this case, feature F3 is a feature of the dataset, and is the feature about which the user wishes to have an explanation
To
Here the user may specify the goals of the prescriptive actions in the
System's response to the question
Example 1: “Reduce: odds of F3C1”
In this example, the user wishes to instruct the System to discover a prescriptive result that result in minimizing the outcome F3C1, where F3C1 is a cardinality of F3
Example 2: “Reduce: F4”
In this example, the user wishes to instruct the System to discover a prescriptive result that result in minimizing the outcome F4. In this case, F4 is not a categorical feature, but a continuous feature.

In order to answer this question with optimized prescriptive rules, the system executes a stepwise approach. The steps involve many localized explorations, feature selections, and successive stabilizations. These steps are described below:

Exploration

Pairs together existing data points and build subsets of datapoints contained by the rules that the two points share.

For example, assume a first data point P1 has categorical features P1F1C1 (the first category of the first feature), and P1F2C4 (the fourth category of the second feature). Assume a second data point P2 has categorical features P2F1C1 (the first category of the first feature), and P2F2C3 (the third category of the second feature). In this case, data points P1 and P2 would have commonality along feature F 1, in the form of category C1. Data points P1 and P2 would not have commonality along feature F2, as P1F2 is C4, and P2F1 is C3.

In order to determine the points that reside within the subset, a filtering operation along each of the dimensions must be executed in order to determine the subset of the dataset that will be scored. The solver module within the system executes these filtering operations many thousands of times within a typical solve operation. Thus, everywhere the scorer is run, the system executes the process depicted in FIG. 8, which uses the transformed dataset.

This “scorer” step's role is to compute an outcome function for that subset, so that it may be compared against other alternative subsets. This step often uses the z-score as the scoring function, because it is frequently the most relevant function that calculates the statistical separation of a subset from a random subset.

If the subset has a positive score, it is identified as an area of interest that the System will pursue it in the following steps. If it does not, then the system will remove that subset from further consideration.

Dimension Reduction

If the paired data points identified in the Exploration step pass the initial screen, the system then tests every feature's contribution to the score of the subset by suppressing the features that match the two points from consideration and rescoring the subset without that specified constraint in place.

After each removal, it computes the score against the remaining subset defined by the remaining dimensions. Again, the system must execute a filtering operation along each of the dimensions in order to compute this score. For example, in a case where the subset was defined by filters in the following way:

F1: P1F1V (the value of Point 1's Feature 1)

F2: P1F2V-P2F2V (the range of values between Point 1's Feature 2 value, and Point 2's Feature 2 value)

In this case, a combined filter is defined against the overall dataset as a filter consisting of Feature 1 being set to all observations where Feature 1 equals C1 (Category 1), AND Feature 2 being all observations where Feature 2 resides between P1's value and P2's value. This system evaluates the score of this subset and stores the value in a local ephemeral memory.

The system then drops conditions one by one in order to determine whether they are locally influential. For example, the system would remove F1 equals C1 from the combined filter, then rescore a subset which does not include this condition. The goal of this process is to determine the conditions of the subset that are locally influential, and thus promising to pass through to the next step within the system's process. While executing this step, the solver module within the system executes these filtering operations many thousands of times within a typical solve operation. Thus, everywhere the scorer is run, the system executes the process depicted in FIG. 7, which uses the transformed dataset.

If the score of the subset is greater than or equal to the current score, then dropping the variable has increased the parsimony of the subset while aiding the score of the subset, and the drop is kept. If not, the system can determine in that specific topology, that specific variable is important to the rule, and should be retained for further exploration.

The set of dimensions that remains after all these reductions, where the system cannot remove any further dimensions, gives the final set of variables that define the subspace.

Expansion

In the final step, the system expands the rule to make it most stable. This function growths on each dimension of the reduced topology, in every possible sequence, until the best possible Z-score for that specific topology has been found:

It adjusts the limits of the subset and expands the rule in every possible direction along the reduced topology, checks each of the expansions against the “scorer” function, and stores the score increase for each possible expansion.

For example, the system will change the filter on F2 from P1F2V-P2F2V, which we will denote V-low-orig and V-high-orig. It will change those values to an updated low index value and high index value along F2, V-low and V-high.

The portion of the system which executes these transformed filter operations, allowing the system to very rapidly evaluate the most optimal boundaries for the ranges, or condition for the variable, are the components within the Transformed Filter Operation, depicted in FIG. 7. This portion of the system is a critical component to the system's ability to execute this operation efficiently.

In this example, the adjustment to the range that increases the score the most is kept, and the system executes that expansion by applying the transformed filter operation many times, repeatedly, along each of the features. The result of this operation is an optimized filtered state, with optimized boundary conditions.

Finally, the System expresses the knowledge as a formalized rule which provides an explanation of the solution by clearly specifying the boundaries or settings that define the subset of datapoints.

Users will adjust the Rule to their constraints and adjust the variables to explore until the Rule/Profile makes business sense to them of their colleagues.

This agglomerative, bottom-up approach, is novel in the mechanism by which it enables the system to create interpretable results that users may implement to facilitate physical changes to existing processes. However, computing this agglomerative approach requires an alternative computational approach. The engine provides a high-speed solver engine architecture to facilitate the greatly increased efficiency of the engine used to process the data, the system uses data transformation engines to produce novel data transformations described below.

Central to the high-speed solver engine is an engine for transforming the dataset into a data structure that can be static and embodied, for example in silicon on a chip. The data transformed may be of arbitrary dimensions. The data structure is a flattened data structure and a two-dimensional data index or lookup table. The data structure is built such that the structure itself embodies pointers so that ranges of data are presorted. In effect, the data structure once built alleviates/eliminates the need for repeated sorting calculations. As the volume of data increases the performance advantage resulting from the use of the data structure increases dramatically, allowing an increase in processing speed of 10, 100 or 1000 times as the volume of data increase.

Thus, the invention provides a system and method for assembling data structures that allow processing high speed multidimensional data analysis at speeds that are orders of magnitude higher than conventional processes.

The invention provides a method of constructing a data structure representing the relative position of ranges of data in a data set of arbitrary dimension and arbitrary modalities. The data structure includes a two-dimensional index and a flattened one-dimensional data structure of arbitrary length. The data structure may be static and embodied in silicon, permanent memory or a continuous block of random-access memory

The structured dataset detailed in this invention is applied by the system many thousands of times within a typical process of executing this subspace search optimization process. The purpose of the high-speed solver engine is to allow the system to extremely quickly determine the datapoints associated with a range or category along a variable within the dataset, or a combination of ranges or categories within the dataset.

The invention provides a prescriptive recommendation system for monitoring a process and identifying and qualifying sources of data, collecting, filtering and analyzing data and transforming the data into a static data structure comprising a two-dimensional index and a flattened one-dimensional data structure of arbitrary length that is used to generate output. The output may be a display of visual images and associated readable textual depictions of results, with a selected framework that is useful as a tool for managers to optimize enterprise performance via specific interventions. Alternatively, or in addition, the output may be in the form of control signals to control equipment, such as computer numerical control machines and other manufacturing equipment to optimize key performance indicators.

The system includes equipment such as communications and data terminal equipment for receiving an incoming data stream over a communications network and storing the incoming data to provide collected data as a metaphorical data lake. The data may be stored in a processor-based server on site or in a cloud-based distribution of servers or a combination of both. The data stream may include data from multiple sources and including data that is observable only, data that is intervenable, external factual data, continuous data, categorical data and timestamp data. A data nature mask in the form of software running on computer equipment is provided to identify and tag data as observable, intervenable and external factual based upon the receipt of an input from an external source such as users or analysts. The system further includes a data ingest engine for evaluating data and capturing as metainformation the names and labels of each feature and the types of feature as continuous numerical data, categorical data and timestamp data. Equipment is provided for receiving and storing user input that identifies select data as key performance indicators.

The data stream also includes measurements of process outcomes, which are aspects of the data whose values are hypothesized to be at least partially dependent upon the process intervenable and observable variable values read at a preceding time. These process outcomes may be, and often are, considered key performance indicators by the organization using the system. The system includes equipment for recording the measurements of process outcomes that may be key performance indicators as well as equipment for receiving a signal from an interface identifying a process outcome as one that should be optimized. The system equipment can also record process outcomes of key performance indicators. As used herein equipment may include computer processing equipment, data storage and communications equipment.

A temporal reconciler, which may be in the form of software running on computer equipment that includes processors, storage and communications equipment is provided to temporarily align data by compiling, aligning and storing a data history associated with a measured process outcome. The temporal reconciler creates a data record that allows past data points that resulted in that process outcome to be matched to the process outcome occurring at a later point in time, so as to provide a consolidated record of conditions that facilitates the discovery of probabilistic evidence.

A probabilistic evidence engine that includes a high-speed solver engine for structuring the data into a flattened data structure and a two-dimensional index for analysis using a data ingest module to provide system output. The probabilistic evidence engine may further comprise an evidence evaluator, an evidence discoverer, an evidence validator, and evidence updater, an evidence updater and a probabilistic evidence catalogue.

The probabilistic evidence engine uses a data ingest module to create an interactive dataset display (IDD) skeleton that contains information about the user and organization who created the IDD, the timestamp of the dataset creation or modification, the number of features within the dataset, the number of records within the dataset, the IDD skeleton further comprising a mapping that points to the location of the data either as a location within the existing system, or outside of the system. The system further comprises equipment for creating and displaying the interactive dataset display and providing a user interface to the system from that IDD or through an Application Program Interface (API) to allow the user to query the system. The user interface allows the users to query the system for specific contextual insights and recommended interventions, wherein the probabilistic evidence engine solves user queries by executing a stepwise process involving successive steps of localized exploration, feature selection, and stabilization. The high-speed solver engine solves user queries around contextual insights and recommended interventions by executing a stepwise process involving successive steps of localized exploration, feature selection, and stabilization.

The invention also provides a method of monitoring a process and providing prescriptive recommendations by identifying and qualifying sources of data, collecting, filtering and analyzing data and transforming the data into a static data structure comprising a two-dimensional index and a flattened one-dimensional data structure of arbitrary length to generate output. The output may take various forms. The output can be a display of visual images and associated readable textual depictions of results, with a selected framework that is useful as a tool for managers to optimize enterprise performance via specific interventions. Alternatively, the output may be in the form of control signals to equipment to optimize key performance indicators.

The method includes the steps of: receiving an incoming data stream over a communications network and storing the incoming data into a system database by a processor-based server or cloud based distribution of servers to provide collected data; using a data ingest engine to evaluate data and capturing as metainformation the names and labels of each feature and the types of feature as continuous (numerical) data, categorical data and timestamp data structuring the data into a flattened data structure and a two-dimensional index for analysis using a data ingest engine to create an interactive dataset display (IDD) skeleton that contains information about the user and organization who created the IDD, the timestamp of the dataset creation or modification, the number of features within the dataset, the number of records within the dataset, the skeleton further comprising a mapping that points to the location of the data, which may be a location within the existing system, or outside of the system.

After the IDD skeleton is created, creating the IDD and providing a user interface the system from that IDD or through an Application Program Interface (API) to allow the user to query the system; and using a high-speed solver engine to solve the query by executing a stepwise process involving successive steps of localized exploration, feature selection, and stabilization.

The method further comprises the step of displaying data and analyses, transmitting recommendations, and receiving action steps on a graphical user interface on a network-enabled processing device over the communications network, the recommendations being based on the collected data.

The invention also provides a method of constructing a data structure representing the relative position of ranges of data in a data set of arbitrary dimension and arbitrary modalities. The method comprising the steps of ingesting data; evaluating the data and assigning data types to the variables under consideration; transforming data into a flattened data structure and creating a two-dimensional index; storing the data in five constituent elements, each of which is a continuous block of random-access memory laid out such that there are 64 bits represented within the memory structure for each value in each of the five constituent elements.

### BRIEF DESCRIPTION OF THE DRAWINGS

FIG. 1 is a full end to end system diagram;

FIG. 2 is a flow diagram depicting the High Level Data Ingest Process;

FIG. 3 is a flow diagram depicting the Data Ingest Module;

FIG. 4: is a flow diagram depicting the Data Ingestion Module Detail View;

FIG. 5: is an Example Untransformed Data Set;

FIG. 6: depicts the creation of a Transformed Data Representation (post-transformation by the System);

FIG. 7A: depicts an Example of a two-dimensional Translation Table Transform used for translation between real values and transformed Data Set (eg. Xl, transformed by the System);

FIG. 7B: depicts an Example of an Initial Transformed Data Set, All Modes

Transform (transformed by the System);

FIG. 7C: depicts an Example of the Record Index Transform (post-transformation by the System);

FIG. 7D depicts an Example of the Mode Mapping Transform (post-transformation by the System);

FIG. 7E depicts an Example of the Modes Index Transform (post-transformation by the System);

FIG. 8 depicts an Example filter operation without point translation executed by the System giving rise to a filtered view of the transformed Data Set (post-transformation by the System);

FIG. 8A—depicts an Example filter operation with point translation executed by the System giving rise to a filtered view of the Data Set (post-transformation by the System);

FIG. 9 depicts a Transformed Solution Space Data Flow;

FIG. 10 depicts an exemplary intelligent dashboard layout;

FIG. 10A depicts an exemplary intelligent dashboard screenshot excerpt;

FIG. 10B depicts an exemplary intelligent dashboard screenshot excerpt;

FIG. 11 depicts and describes a system architecture for an implementation of the system.

### DETAILED DESCRIPTION

The system and method described herein allow creation of a flattened data structure (that may be embodied in a static physical form) from a data set of arbitrary dimension and modalities. The data structure represents the relative position of ranges of data in a data set of arbitrary dimension and arbitrary modalities. As shown in the drawings and described here the method comprising steps of ingesting data; evaluating the data and assigning data types to the variables under consideration; transforming data into a flattened data structure and creating a two dimensional index; and storing the data in five constituent elements, each of which is a continuous block of random access memory laid out such that there are 64 bits represented within the memory structure for each value in each of the five constituent elements. With the flattened data structure, a high-speed solver engine may be provided by using a two-dimensional index and a flattened one-dimensional data structure of arbitrary length.

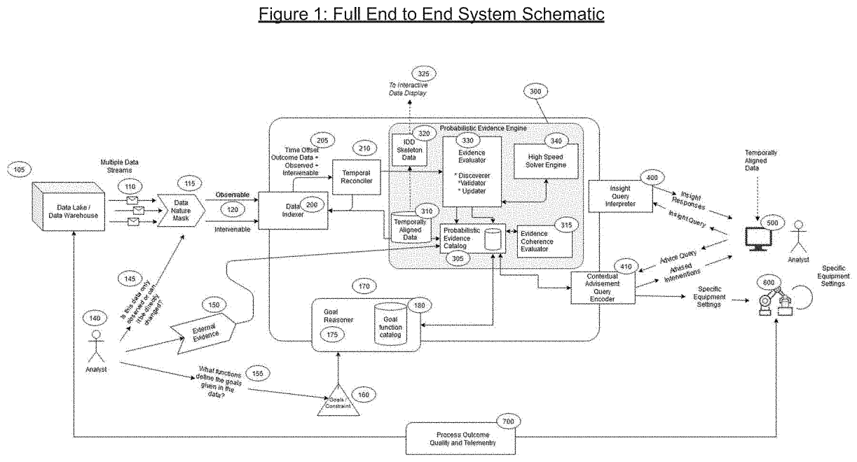

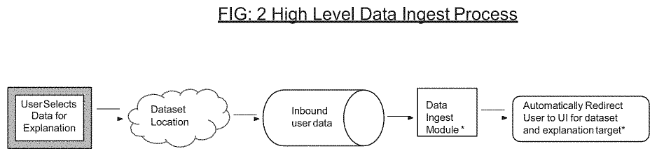

FIG. 1 depicts the overall system and FIGS. 2-4 depict the high-level process whereby the system takes each feature of the dataset one by one and performs a rank encoding of the values. For example, the values [1.2, 3.6, 1.1] would be originally encoded as [1, 2, 0] if the embodiment is naturally inclined toward zero-indexes, and [2, 3, 1] if the embodiment of the system is more naturally inclined toward 1-indexed representation. Missing values are always encoded as the first rank.

As shown in FIG. 1, the system of the invention may, by way of example, be used in two primary in-situ implementations. First, the system can be used in capturing information from a manufacturing process to support prescriptive manufacturing recommendations and optimizations. In this example, the prescriptive guidance learned and provided by the system through the Interactive Data Display 500 or control signals to equipment 600 helps the manufacturing organization to attain its goals, such as reducing scrap or improving product yield. In a second example, the system can be used to capture information from financial transactions, such as credit scoring or insurance decisions, and then using that information to provide prescriptive recommendations and optimizations of decisions in those transactions for the financial institution through the Interactive Data Display 500. The implementation of the system in both contexts is described as follows.

Use Case: Manufacturing Optimization

In this application the system is placed into the network of devices and used to monitor all key performance indicators associated with a given manufacturing process related to the output of a particular product. This includes information about the yield and the quality of the product. It may also concern other key performance indicators of interest, or KPIs, that the manufacturing organization wishes to track and optimize.

The data for this application, includes the information regarding the process itself, which will include telemetry in the process, i.e., the in situ collection of measurements or other data at remote points and their transmission as data streams to receiving equipment for use by the system. This will include readings from the individual machines, such as the settings of those machines as well as the readings on the machines themselves while the process is underway, such as pressure, temperature, vibration, plus other readings that are relevant to the process. Those frequently come from IOT devices or other sensors on the pieces of equipment involved in the process. In addition, this process data will include the process outcomes, such as the overall yield of the process, the quality of the items produced, or the scrap generated by the process. It may also include other economic factors (external factual data) as the overall cost of the process.

The data streams all feed to data storage accessible to the system (metaphorically a “data lake” 105). Data relevant to the process so the system can understand the state of a wide variety of conditions, settings or factors that affect the process. The data in multiple streams 110 is time stamped for temporal reconciliation and data streams 110 pass through a data nature mask 115 and are categorized as observable, intervenable, external factual etc. and stored. Collectively the stored data comprises data sufficient to allow “awareness” of all significant influences on the process. Using the available data, the system outputs (via the Interactive digital display, IDD 500 or through direct control signals to equipment 600) guidance to users based on analysis of all significant influences.

Many other data types can be joined with this data including, for example, external factual data. These may include information about the suppliers that provide the various components and products that are the constituent elements of the eventual manufactured good. It may also include information about the ambient conditions under which the manufacturing process takes place such as the temperature and humidity. The data may also include the time of day in which the manufacturing process takes place. Finally, information about the workforce itself may be included such as the shift. Or the information regarding the relative experience levels of the operators of the equipment that is used in the manufacturing process.

This data is transformed and joined as depicted in the data indexer 200 in the diagram. Note that this information may or may not flow through a data lake 105 prior to it being joined and transformed. Although this step is common and frequently makes the overall approach easier to execute it is not explicitly required in order for the process to work.

In most cases, the Key Performance Indicator (KPI) that the organization will want to track is the process outcome, such as yield, or scrap. An example of this outcome might be the overall process yield at or above a certain level of quality threshold. Another example of this KPI might be the overall scrap level that is generated by the process. In the former case, the manufacturing organization will seek to maximize the process yields such that they can maximize the amount of good that they are producing. In the other case, the manufacturing organization wishes to minimize the amount of scrap that they produce in this process.

Although these two goals may seem like they are inversely related to one another, practice, they almost never have the same set of factors. Rather, there are things that the organization should do to maximize yield. Which may be partially but not totally related, that are required to minimize the bad outcome—the scrap level.

As depicted in the diagram, much of the telemetry information is tracked live in a monitoring process by the system. The system captures this information in a time series such that it can eventually reconcile that information with other settings and ambient information and workforce information, such that it is joined together from the original data transformation step. Most importantly, the system is set up in such a way that it can reconcile the eventual process outcome with the values associated with the process telemetry. This involves ensuring that the system tracks not just the telemetry values of the equipment and ambient/environmental data throughout the process, but that it can reconcile and match that information to the outcomes that will eventually be determined at some later point in time. Temporal reconciliation allows the system to reason about the effects of the process Telemetry on the eventual outcome, especially when combined with the supplier info, ambient environmental information and workforce information described above.

In effect, the system compiles a data history that resulted in an outcome—whether the outcome is good or bad is not known until the outcome occurs, but once the outcome occurs there is a data history of the conditions that resulted in that favorable (or unfavorable) outcome—as data and outcomes are accumulated, the system can recommend interventions to improve outcomes and the outcome resulting from interventions can be tracked.

The system ingests this information together with the process outcome and encodes this into a set of integers as explained in the description of the system operation. This translation into another representation allows the system to reason about all the combined set of information together as an encoded set of bits rather than operating on the information in its raw form. Due to the efficient way that the system is able to represent the data, it is able to capture the rules associated with the effects between the data about the process and the desired outcome states.

As a concrete example, we will consider a system where a process manufacture is creating an aerospace part. Due to the precision requirements of this part, this is typically an extremely high precision, lower yield process. In a typical installation, the manufacturer has a data lake in process that has already captured information about the ambient conditions of the manufacturing process such as the ambient humidity, temperature, time of day, weather conditions, etc. That “data lake” often also includes information regarding the levels of experience of the workforce, including the level of experience of the operator with each individual piece of equipment, the number of years of experience overall that the operator has in manufacturing aerospace components, and the level of Education and training of each of these staff members both overall, and operating the individual pieces of equipment on the production line.

In this scenario, the system may generate a rule of the following form:
When all these conditions are true:
Morning Shift Team
Supplier Alpha for part B
Temperature reading at point 34 in machine is between 38 and 40 degrees C.
Vibration at sensor 5 is below 304
THEN
Overall process yield increases from the baseline level of 45% to 78%
   In other words, the system is able to understand and reason about these levels and provide prescriptive advice on how to optimize the process along that particular dimension based upon the information being tracked and reasoned about. Note, however, that these recommendations may or may not include only information about the possible interventions on the system. The system provides a way for individuals to make it aware of the aspects of the data where intervention is possible, and where it is not.

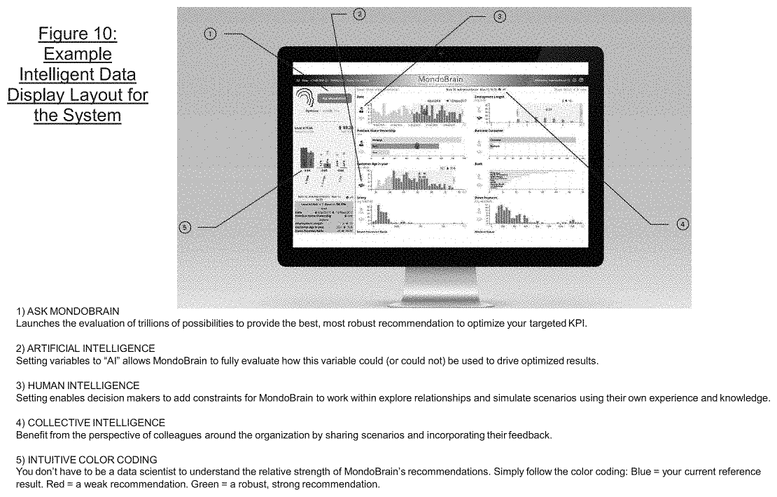

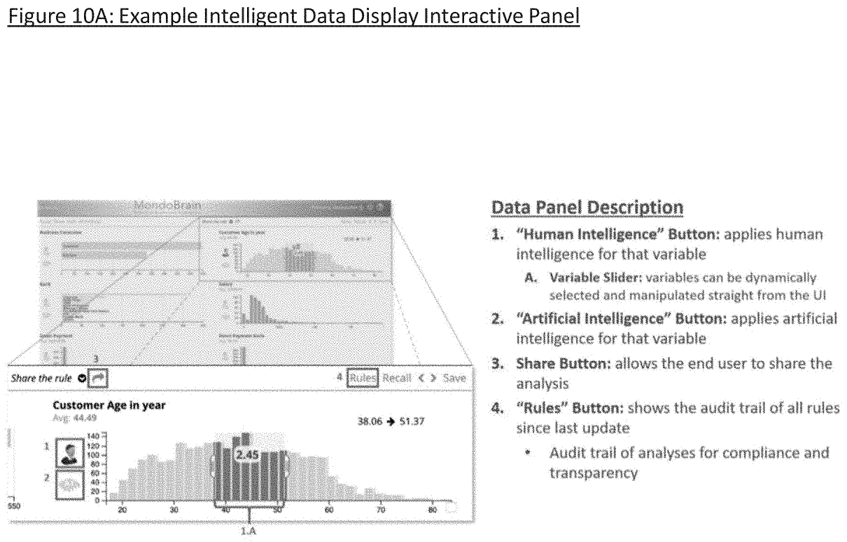

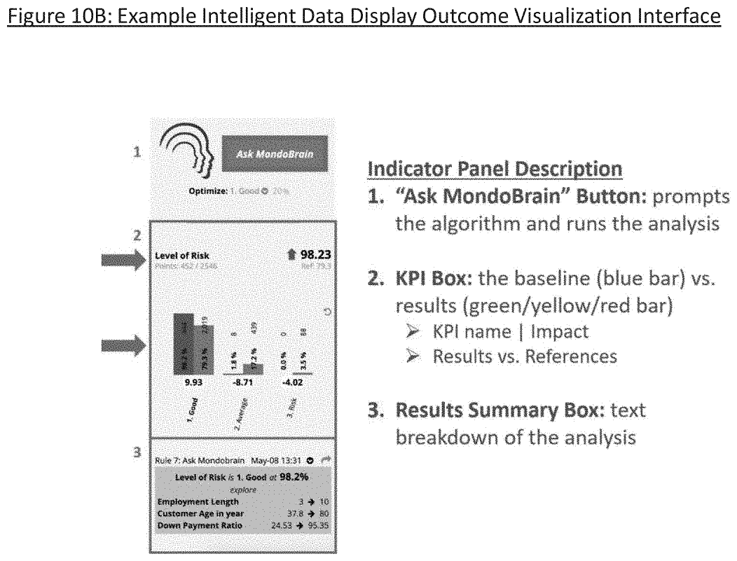

The system provides a user interface called an Integrated Data Display 500 two screenshot excerpts of which are shown in FIGS. 10A and B. The Human Intelligence and Artificial Intelligence toggle allows the user to interact with the system to specify the nature of the interaction and derive direct insights only along specific requested variables. Typically, these variables will follow the observed and intervenable pattern, such that insights may be determined from all variables, but advice on how to guide a process toward a more optimal outcome, or avoid a negative outcome, will be determined by by selecting intervenable variables for probabilistic evidence engine learning.

This information is sent to the probabilistic evidence engine 300 by using the “Ask” button on the interactive data display 500, shown on the panel depicted in FIG. 10B as the “Ask MondoBrain”. This signals the system to capture the current state of the variables from the collection of observations that the analyst has established using the above interface and passes that information to the probabilistic evidence engine module for further analysis. The result of the optimization performed by the probabilistic evidence engine will be the information displayed in the results summary section of the interactive data display 500.

System Diagram And Description:

As shown in FIG. 1, inputs to the system are provided by both the analyst (user) 140 and multiple external data streams from a data lake/data warehouse 105. The data streams 110 contains all information that is post transform and join operations. Typically, this information will come from a data lake or a data warehouse 105.

The user 140 provides information to the system that allows the system to partition (through, for example, data nature mask 115) the data into both observable data and intervenable data 120. The analyst 140 on each of the individual features in the data set to define whether that data can be observed only, or whether it can be directly changed. As used herein the analyst may be a user or a person setting the system up for users. An example of a piece of information that can only be observed and not change directly would be the temperature reading on a gauge. That information is captured and read but there is no control to directly change it. An example of information that can be intervened upon would be a dial that controls the flow speed of a lubricant through the portion of machine that the temperature gauge is reading.

Once this information is provided to the system it flows into the data indexer 200. The data indexer 200 stores all incoming data and indexes it by time, as well as information identifying whether or not that data is observable or intervenable at the time of reading 205. At this point the data is not yet ready to be reasoned upon. the temporal reconciliation 210 must align the data in order for it to synchronize the input data with outputs that are typically read at a later point in time. Only after temporal reconciliation is the data ready to be processed and reasoned about. An example of the need for temporal reconciliation arises when we consider the case of a good which has been manufactured on a manufacturing line. Observable information includes all readings from the machine as well as ambient environmental information within the manufacturing facility. Intervenable information includes all of the settings that exists on those machines, the choices of suppliers of component parts, the workforce training level of the employees operating the machines, and any other choices that have been made during the process.

However, not present at the time of reading this information is the goal for an outcome that the organization has for this product—for example, to increase the yield and decrease scrap. To get this information, the organization must wait until the manufacturing of each specific good has been completed and a quality assurance evaluation has been performed on those goods. Only then can they understand the outcome of their process. Thus, the information regarding the goal of the process is not available at the same time as the telemetry about the process and the settings and decisions made during the execution of the process. Temporal reconciliation 210 aligns the information captured during the process with the outcome of the process which is only available at some future point in time.

Once this information has been temporally aligned, the temporal reconciler can place this information back into the data indexer 200, as temporally aligned data. At that point, the system connects the prepared data to the Evidence Evaluator.

The Evidence Evaluator 330 is the portion of the system that makes request to the high speed solver engine 340 of the Probabilistic Evidence Engine 300 on specific rules to be solved.

In this step, one of several alternative approaches can be run by the evidence evaluator 330 system in order to do one of the following:
Discover new evidence
Validate (or invalidate) evidence which has already been discovered
Update existing evidence

Each of these three processes calls the probabilistic evidence engine using different inputs.

Evidence Discoverer:

Here, the probabilistic evidence engine 300 is running on all indexed data related to the goal function catalog 180 as the data stream enters the system and is indexed and organized with temporal reconciliation (200, 210), the system learns patterns associated with this data. It does so by capturing this information and passing it to the probabilistic evidence engine 300 previously described. This engine discovers rule based segmentations that are probabilistic in nature, by optimizing the statistical separation between the data in the subpopulation defined by a combination of conditions (a rule) And a reference population, which is usually the collection of all data.

These segmentations form the probabilistic evidence which the system uses to reason about the goals 160 that the analyst 140 desires to optimize.

When the evidence evaluator discovers new probabilistic evidence, the system checks the probabilistic evidence catalog 305 to determine whether that evidence already exists in the system. If the evidence does not already exist in the system, then the system has discovered new evidence and that probabilistic evidence is then encoded into the Probabilistic Evidence Catalog 305.

Evidence Validator:

Here, the process works very similar to the evidence discovery process detailed above. However, in this case the evidence evaluator 330 determines that evidence already exists within the probabilistic evidence catalog 305 specified by the same, or nearly the same, set of conditions. In this situation the system will validate that the evidence it already believes about the world is consistent with the new observations it has seen recently. If the system determines that the evidence is valid and coherent then the information and evidence will be reinforced within the probabilistic evidence catalog. The system executes this process using the evidence coherency evaluator process 315.

Evidence Coherency Evaluator:

The Evidence Coherence Evaluator 315 is connected to the evidence discoverer 330 part of the probabilistic evidence engine 300 and evaluates whether the evidence that the system has seen in the past retains stable level of performance. The system evaluates this performance and stability by assessing whether more recent data, specified by a user controllable time window, exhibits the same level of separation between distributions between the observations made within the time window, and prior to the time window.

The system uses this continuous feedback loop to discover trust regions where specific pieces of probabilistic evidence in the probabilistic evidence catalog 305 performs better, and where it performs worse. The system characterizes these regions explicitly, allowing analysts to understand the context specific effectiveness of their model within each portion of the data domain. The system then applies these insights to produce updated rule insights and recommended additional learned features, allowing the system to continually improve and adapt.

This process of continuous back testing of the data may result in two rules that disagree with one another. In this case, the system triggers the probabilistic evidence engine 300 to learn new more suitable rules.

Evidence Updater:

As stated, each time a rule is used in an evaluation, a history of that rule's applicability to a specific situation is captured, which can ultimately be reconciled against the desired real-world goals for the process. The system can use these inputs, rule applications, and actual results to perform rule monitoring, and continually improve the rules used by the system. When the system deems it necessary, these rules can be updated.

Each time a rule is used in an evaluation, a history of that rule's applicability to a specific situation is captured, which can ultimately be reconciled against the desired real-world goals for the process.

The system can use these inputs, rule applications, and actual results to perform rule monitoring, and continually improve the rules used by the system, helping analysts react optimally and quickly to changes in risk exposure or customer behaviors.

The system will provide a continuous feedback loop. The system discovers trust regions where the rules perform better, and where they perform worse. The system characterizes these regions explicitly, allowing analysts to understand the context specific effectiveness of their model within each portion of the data domain. The system then applies these insights to produce updated rule insights and recommended additional learned features, allowing the system to continually improve and adapt.

Alerting, to escalate any situation where the application of the previously learned rules on new data has performance below the threshold performance level;

Auto-Learning, be triggered by the conditions listed above and possibly other conditions, which will run the process to produce new probabilistic evidence from an updated data set from the data lake or warehouse 105;

Review and Approval Management, which will provide a dashboard to relevant USER stakeholders to ensure human review for potential rule changes;

Publication, to automatically publish the probabilistic evidence as a business rule into production in the an external rule system. Typically, this process, for example only occurs once a human expert has approved the potential update. Specific implementations may involve direct connection to external systems which receives the signal and triggers a rule publication without human review and approval.

Change Tracking, to automatically track all published changes and provide an audit trail for user risk analysts and senior decision makers to ensure compliance with internal risk guidelines, and external regulatory authorities.

Rule Management System Usage:

The system often utilizes the system's core Software Development Kit (SDK) as a component allowing for these automated direct connections to be established. This configuration allows the system to continuously update the probabilistic evidence catalog with newly discovered evidence on a regular basis, and that evidence to be propagated to all concerned operational systems and users.

In FIG. 2, the user selects a data source for ingestion, which points to a dataset location, which is then used by the system to create a data pipeline for the dataset ingestion in the analysis system, which goes through the data ingest module, within the system, which ultimately redirects the user to the interactive visualization system that enables the user to interact with the representation of the datapoints created by the system.

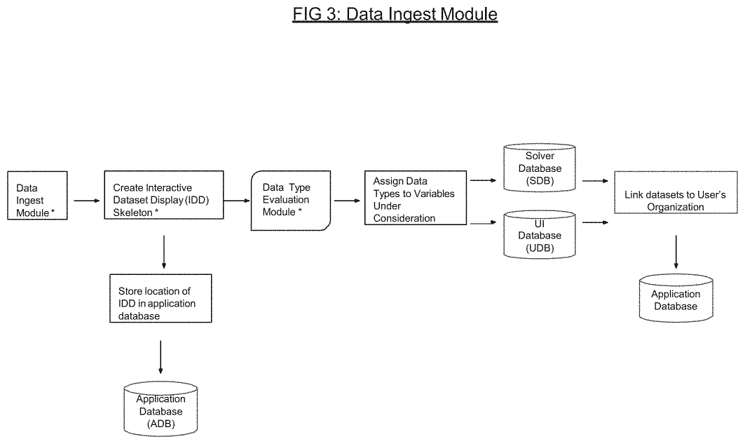

FIG. 3 depicts the data ingest module, which creates the skeleton for the interactive data display, and performs data type evaluation of the dataset, assigning types to each feature within the dataset. This is then stored in a database for both the high-speed optimization solver and the user interface and is made accessible through linkages that the system automatically creates to the users organization, which then get stored in the application database.

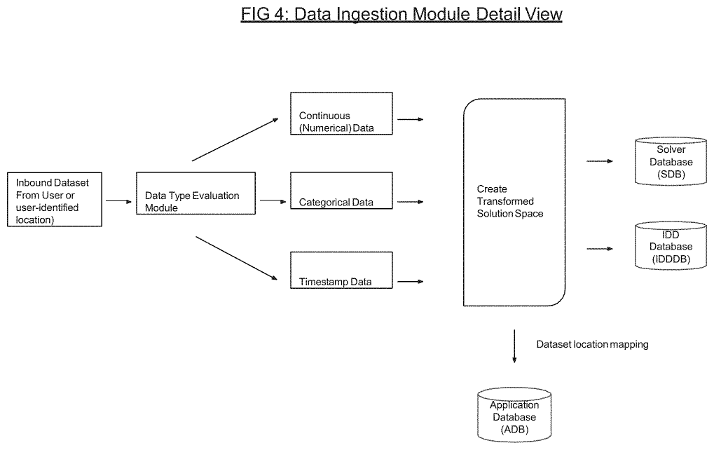

FIG. 4 depicts the Data Ingestion Module Detail View, which provides an overall flow of the dataset to the data type evaluation module. This data type evaluation module performs an assignment of the data types to either continuous, categorical, or temporal (timestamp) feature types. This then leads to the creation of the transformed data structure.

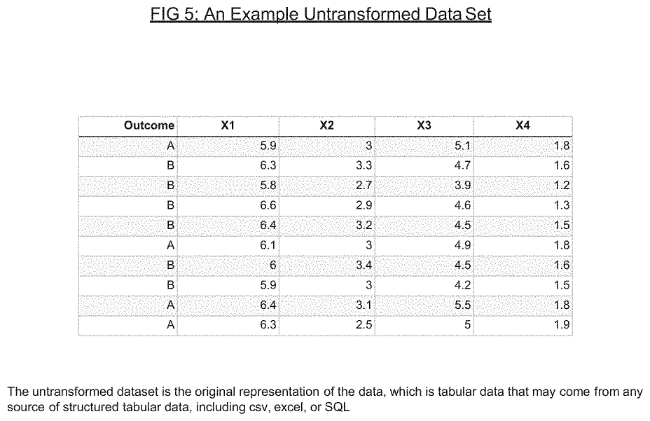

FIG. 5 depicts an example of a type of dataset that the user may provide to the system for analysis, as depicted in FIG. 1. This dataset has an outcome column which is categorical, and four numerical variables, as well as 10 observations (data points).

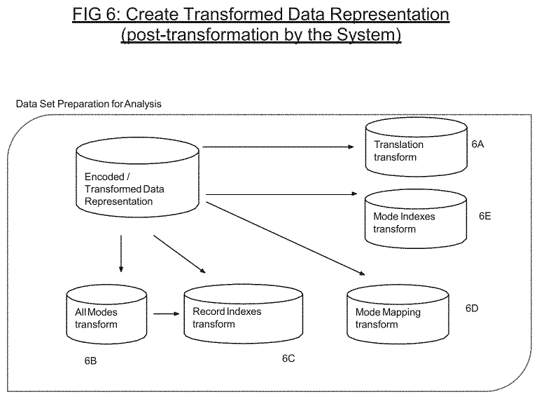

FIG. 6 depicts the assets created when the system creates the transformed data representation. We will go into each of the assets in more detail, but the transformed representation contains each of the following:
The “All Modes” structure, which is the rank encoded and transformed data representation of all of the values in the original dataset from FIG. 4
The “Record Indexes” transformation
A “Mode Mapping” transformation
A “Mode Indexes” transformation
A “Translation Table” transformation

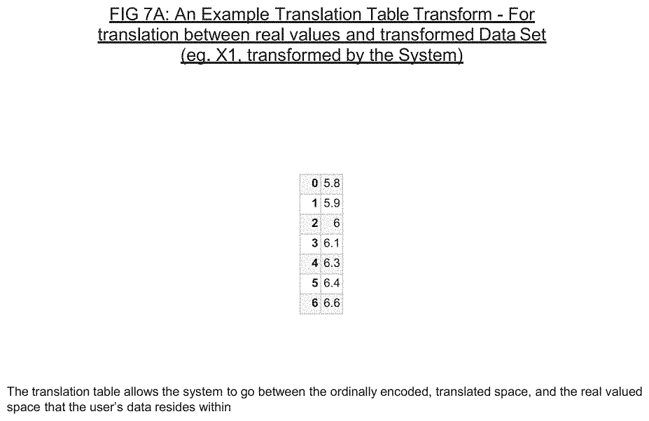

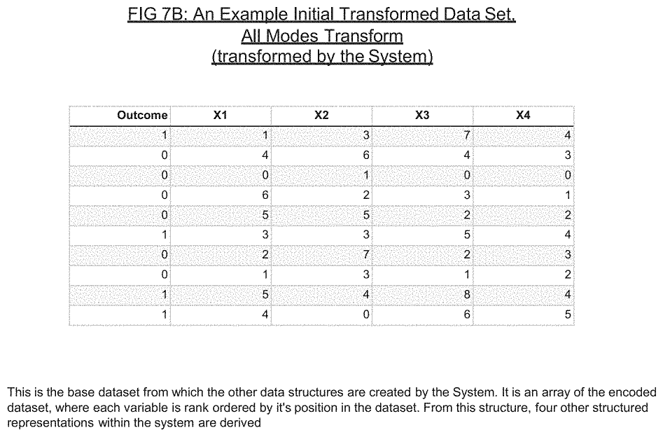

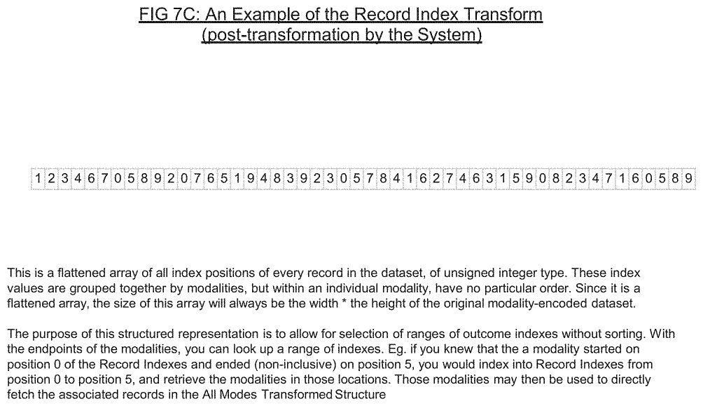

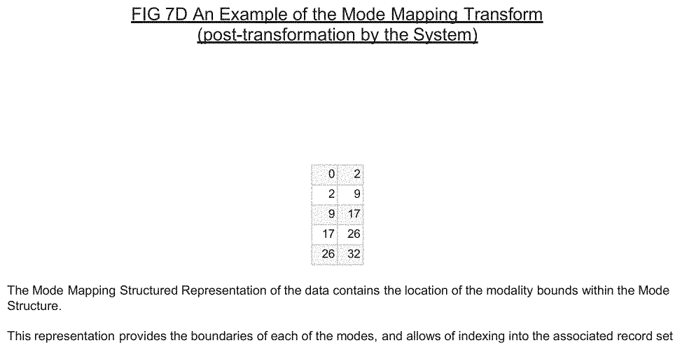

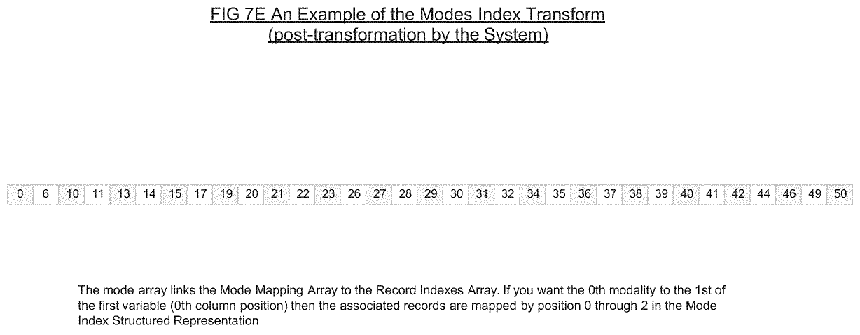

FIG. 7A: depicts an Example of a two-dimensional Translation Table Transform used for translation between real values and transformed Data Set (eg. X1, transformed by the System). FIG. 7B: depicts an Example of an Initial Transformed Data Set, All Modes Transform (transformed by the System). FIG. 7C: depicts an Example of the Record Index Transform (post-transformation by the System). FIG. 7D depicts an Example of the Mode Mapping Transform (post-transformation by the System). FIG. 7E depicts an Example of the Modes Index Transform (post-transformation by the System).

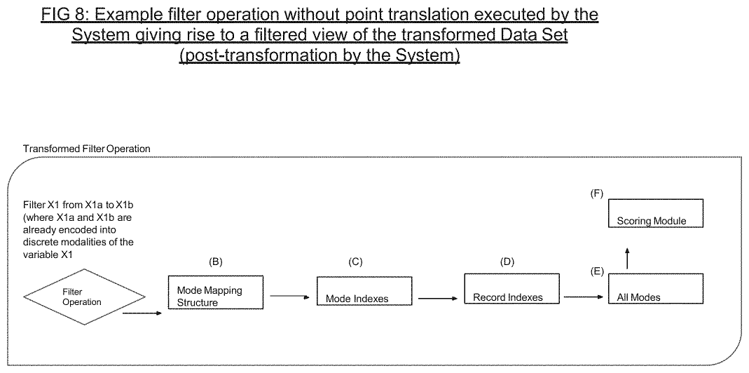

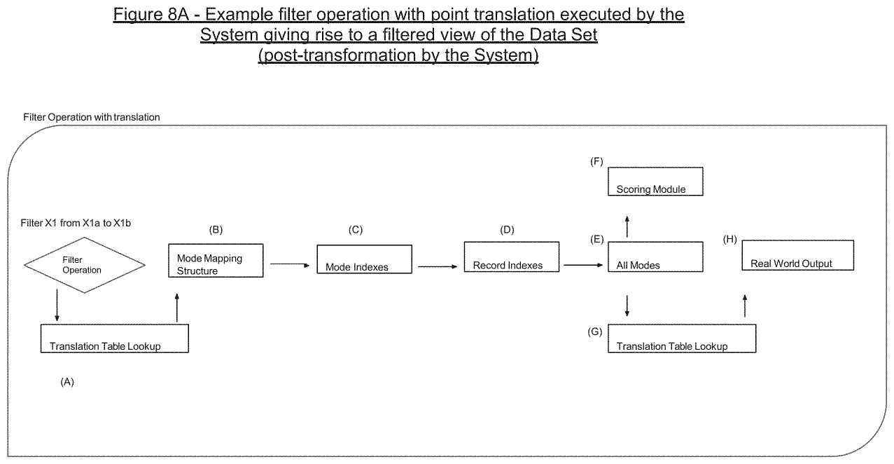

FIGS. 8 and 8A depict use of the data structures in the execution of a fast filtering operation. FIG. 8 depicts an Example filter operation without point translation executed by the System giving rise to a filtered view of the transformed Data Set (post-transformation by the System). FIG. 8A—depicts an Example filter operation with point translation executed by the System giving rise to a filtered view of the Data Set (post-transformation by the System).

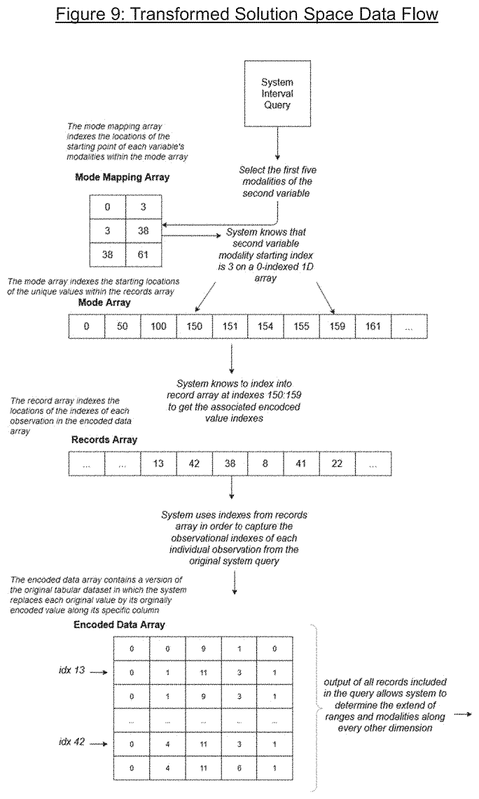

FIG. 9 depicts a Transformed Solution Space Data Flow—the internal flow of a specific filter operation. The advantage of this approach is that it allows for the transformation and resultant representation allows the embodiment of the system to physically represent these constituent elements of the transformed representation to have a defined in-memory structure which contains the precomputed information about the mapping of the data records to the ranges within each variable. Within the embodiment, each of which has individual 64 bits. This allows the system to represent 2 \hat{ }64, or 18,446,744,073,709,551,615 values.

FIG. 10 depicts and describes an exemplary intelligent dashboard layout with explanation provided on the drawing. FIGS. 10A and 10B are exemplary screenshot excerpts of the IDD. 500.

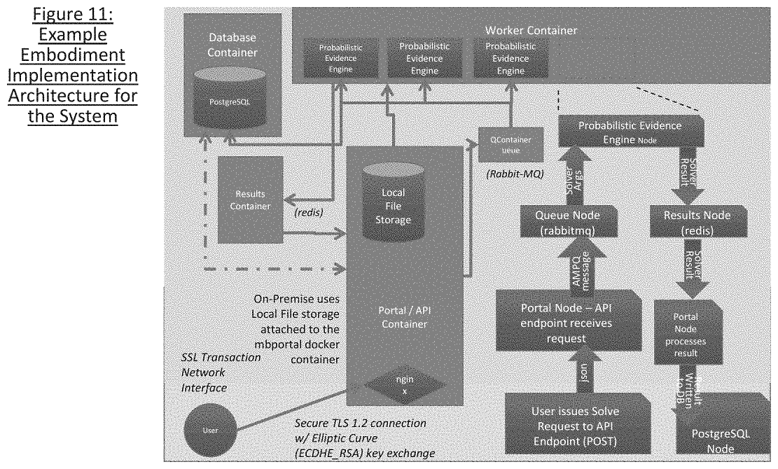

FIG. 11 depicts and describes system architecture for an implementation of the system used on premises or through the cloud. Each Worker Node in the diagram depicts a probabilistic evidence engine. Multiple probabilistic evidence engines may be used in a given embodiment, in which case the calculation load between those engines are balanced by a load balancer. This figure illustrates an example embodiment of the communication pathway by which a signal from an outside source, in this case called the user, may travel in order to affect the transformations of the information performed in the probabilistic evidence engine. The schematic also depicts a set of technologies commonly used to allow access of the probabilistic evidence to outside systems.

The forgoing describes exemplary embodiments. Those skilled in the art will appreciate that other embodiments are possible. The invention improves the performance of data processing equipment by one or more orders of magnitude by providing engines to transform a data set into a flattened data structure that has relations between the data points “pre-calculated” and embodied within a data structure that may be static. The data structure represents the relative position of ranges of data in a data set of arbitrary dimension and arbitrary modalities. The method includes steps of ingesting data; evaluating the data and assigning data types to the variables under consideration; transforming data into a flattened data structure and creating a two dimensional index; and storing the data in five constituent elements, each of which is a continuous block of random access memory laid out such that there are 64 bits represented within the memory structure for each value in each of the five constituent elements. As such the processor can obtain the desired output with a small fraction of the calculation required with conventional equipment. The savings in processing increases exponentially as the size of the data set increases taking the improvement in efficiency from one order of magnitude (10×) to as much as 1000× or more. The invention thus provides greatly increased speed improvements in analyzing available data sets, identifying data most relevant to a desired outcome, and providing an interpretable result that can be used to alter physical system parameters. The system allows for discovery of explanations for observed outcomes within data and generate recommendations to drive those outcomes toward desired stats and avoid undesired states. Users may analyze variables (data) to drive a variable toward a desired outcome or drive a variable to avoid an undesired outcome. Variables analyzed may include, for example, tolerances for a component shape or settings for a piece of equipment in a process. This output is then used to perform an action that will alter a physical component.

1) A prescriptive recommendation system for monitoring a process and identifying and qualifying sources of data, collecting, filtering and analyzing data and transforming the data into a static data structure comprising a two-dimensional index and a flattened one-dimensional data structure of arbitrary length that is used to generate output including at least one of a display of visual images and associated readable textual depictions of results, with a selected framework that is useful as a tool for managers to optimize enterprise performance via specific interventions and control signals to equipment to optimize key performance indicators, the system comprising:
equipment for receiving an incoming data stream over a communications network and storing the incoming data to provide collected data, the data stream comprising data from multiple sources and including data that is observable only, data that is intervenable, external factual data, continuous data, categorical data and timestamp data
a data nature mask for identifying and tagging data as observable, intervenable and external factual based upon the receipt of an input from an external source;
a data ingest engine for evaluating data and capturing as metainformation the names and labels of each feature and the types of feature as continuous numerical data, categorical data and timestamp data;
equipment for receiving and storing user input identifying select data as key performance indicators
the data stream further including measurements of process outcomes, which are aspects of the data whose values are hypothesized to be at least partially dependent upon the process intervenable and observable variable values read at a preceding time
equipment for recording the measurements of process outcomes that may be key performance indicators
equipment for receiving a signal from an interface identifying a process outcome as one that should be optimized
equipment for recording process outcomes of key performance indicators
a temporal reconciler for compiling, aligning and storing a data history associated with a measured process outcome so as to create a data record that allows past data points that resulted in that process outcome to be matched to the process outcome occurring at a later point in time, so as to provide a consolidated record of conditions that facilitates the discovery of probabilistic evidence
a probabilistic evidence engine that includes a high-speed solver engine that operates by structuring the data into a flattened data structure and a two-dimensional index for analysis using a data ingest module to provide system output.

2) A prescriptive recommendation system according to claim 1, the system further comprising a user interface to the system to allow the users to query the system for specific contextual insights and recommended interventions, wherein the probabilistic evidence engine solves user queries by executing a stepwise process involving successive steps of localized exploration, feature selection, and stabilization.

3) A prescriptive recommendation system according to claim 1, wherein the system output comprises a display of visual images and associated readable textual depictions of results, with a selected IDD framework that is useful as a tool for managers to optimize enterprise performance via specific interventions

4) A prescriptive recommendation system according to claim 1, wherein the system output comprises control signals to equipment to optimize key performance indicators

5) A prescriptive recommendation system according to claim 1, wherein the equipment for receiving an incoming data stream over a communications network and storing the incoming data is a processor-based server.

6) A prescriptive recommendation system according to claim 1, wherein the equipment for receiving an incoming data stream over a communications network and storing the incoming data is a cloud-based distribution of servers.

7) A prescriptive recommendation system according to claim 1, wherein the probabilistic evidence engine that includes a high-speed solver engine for structuring the data into a flattened data structure and a two-dimensional index for analysis using a data ingest module creates an interactive dataset display (IDD) skeleton that contains information about the user and organization who created the IDD, the timestamp of the dataset creation or modification, the number of features within the dataset, the number of records within the dataset, the IDD skeleton further comprising a mapping that points to the location of the data either as a location within the existing system, or outside of the system;
the system further comprising equipment for creating and displaying the interactive dataset display and providing a user interface to the system to allow the user to query the system.

8) The prescriptive recommendation system according to claim 1, wherein the high-speed solver engine solves user queries around contextual insights and recommended interventions by executing a stepwise process involving successive steps of localized exploration, feature selection, and stabilization.

9) The prescriptive recommendation system according to claim 1, wherein the high-speed solver engine comprises a static data structure comprising a two-dimensional index and a flattened one-dimensional data structure of arbitrary length.

10) The prescriptive recommendation system according to claim 1, wherein probabilistic evidence engine further comprises an evidence evaluator, an evidence discoverer, an evidence validator, and evidence updater, an evidence updater and a probabilistic evidence catalogue.

11) A method of monitoring a process and providing prescriptive recommendations by identifying and qualifying sources of data, collecting, filtering and analyzing data and transforming the data into a static data structure comprising a two-dimensional index and a flattened one-dimensional data structure of arbitrary length that to generate output comprising at least one of a display of visual images and associated readable textual depictions of results, with a selected framework that is useful as a tool for managers to optimize enterprise performance via specific interventions and control signals to equipment to optimize key performance indicators, the method comprising the steps of:
receiving an incoming data stream over a communications network and storing the incoming data into a system database by a processor-based server or cloud-based distribution of servers to provide collected data;
a data ingest engine for evaluating data and capturing as metainformation the names and labels of each feature and the types of feature as continuous (numerical) data, categorical data and timestamp data
structuring the data into a flattened data structure and a two-dimensional index for analysis using a data ingest engine to create an interactive dataset display (IDD) skeleton that contains information about the user and organization who created the IDD, the timestamp of the dataset creation or modification, the number of features within the dataset, the number of records within the dataset, the skeleton further comprising a mapping that points to the location of the data, which may be a location within the existing system, or outside of the system;
after the IDD skeleton is created, creating the IDD and providing a user interface the system from that IDD or through an Application Program Interface (API) to allow the user to query the system; and
using a high-speed solver engine to solve the query by executing a stepwise process involving successive steps of localized exploration, feature selection, and stabilization.

12) The method of claim 1, further comprising the step of displaying data and analyses, transmitting recommendations, and receiving action steps on a graphical user interface on a network-enabled processing device over the communications network, the recommendations being based on the collected data.

13) A method of constructing a data structure representing the relative position of ranges of data in a data set of arbitrary dimension and arbitrary modalities, the method comprising the steps of
ingesting data;
evaluating the data and assigning data types to the variables under consideration;
transforming data into a flattened data structure and creating a two-dimensional index;
Storing the data in five constituent elements, each of which is a continuous block of random-access memory laid out such that there are 64 bits represented within the memory structure for each value in each of the five constituent elements.
